(19) United States
(12) Patent Application Publication
(10) Pub. No.: US 2002/0165734 A1
(43) Pub. Date: Nov. 7, 2002

(54) System and method for automating the completion of complex tasks

(75) Inventor: John Halamka, Boston, MA (US)

Correspondence Address: FOLEY AND LARDNER, SUITE 500, 3000 K STREET NW, WASHINGTON, DC, 20007, US

(73) Assignee: Caregroup Healthcare System

(21) Appl. No.: 10/135,373

(22) Filed: May 1, 2002

Related U.S. Application Data
(60) Provisional application No. 60/287,392, filed on May 1, 2001.

(51) Int. Cl. G06F 17/60

(52) U.S. Cl. 705/2

(57) ABSTRACT

In a system and method for automatically completing tasks, a request to complete a task is received, and a plurality of rules that must be satisfied to complete the task are identified. After an event associated with the task in the request is received, it is determined whether the event satisfies all of the plurality of rules that must be satisfied to complete the task. Additional events are received and analyzed to determine whether they satisfy the plurality of rules until all of the plurality of rules have been satisfied.

### RELATED APPLICATIONS

This application claims priority to Provisional Application Serial No. 60/287,392, filed on May 1, 2001 under 35 U.S.C. §119(e). The content of the Provisional Application Serial No. 60/287,392 is hereby incorporated by reference.

### FIELD OF THE INVENTION

The present invention relates generally to automatically completing tasks, and more particularly to a system and method for receiving, processing, and completing complex tasks related to healthcare.

### BACKGROUND OF THE INVENTION

In a healthcare environment, such as a physicians office or a hospital, various employees are assigned the duty to perform a variety of healthcare related tasks. These tasks include, for example, making appointments, generating referrals, and refilling prescriptions. When one of these tasks is to be completed, an individual who needs to have the task performed, usually the patient, typically calls a department in charge of completing the task. The patient provides information to an individual working in the department regarding what the task is and the individual working in the department performs the task. Depending upon the time it takes to complete the task, the individual working in the department may notify the patient during the call that the task is complete or call the patient at some later point.

This system has several inefficiencies. First of all, the patient requesting the task must correctly identify the department in charge of doing the task. Identifying the correct department may take time and may not be readily available. In addition, any errors in identifying the department may result in needless delay and frustration in getting the task done.

Another inefficiency results from the requirements of the healthcare organization with respect to handling and receiving requests to complete the tasks. The organization typically has one or more people to receive the requests from a patient. There may be different people receiving the request for each type of task. For example, the person or persons receiving requests for a prescription may be different from the person or persons receiving requests for physician referrals. As a result, the organization has a large staffing requirement simply to receive requests from patients to complete certain tasks.

In this organizational system, it is generally the responsibility of the person receiving the request from the patient to accept information from the patient, write it down in a form associated with the type of task requested by the patient, and pass it to a person in the department who performs the task. Manually drafting the request may result in communication errors, both from the patient to the person taking the information, as well as from that person to the person performing the task. Moreover, such a system requires multiple layers of personnel in the organization to be involved in the completion of the task.

### SUMMARY OF THE INVENTION

Briefly, in one aspect of the invention, a method performed in a computer system for the automatic completion of a healthcare related task includes receiving a request at the computer system via a network from a user to complete a healthcare related task. A plurality of rules that must be satisfied to complete the task are identified from a database stored in the computer system. The occurrence of an event associated with the task is recognized, and it is determined whether the event satisfies all of the plurality of rules that must be satisfied to complete the task. The recognizing and determining are repeated if any of the plurality of rules have not been satisfied.

In another aspect of the present invention, the task is performed if all of the plurality of rules have been satisfied, and a notification is transmitted to the user who submitted the request when the performance of the task has been completed.

### BRIEF DESCRIPTION OF THE DRAWINGS

FIG. 1 is a block diagram of an automated task completion system consistent with the present invention.

FIGS. 2A-2C are tables for tasks, rules and events processed by the automated task completion system consistent with the present invention.

FIG. 3 is a flow diagram of an automated task completion consistent with the present invention.

FIG. 4 is a flow diagram for entering a task in the automated task completion system consistent with the present invention.

### DETAILED DESCRIPTION OF THE PREFERRED EMBODIMENT

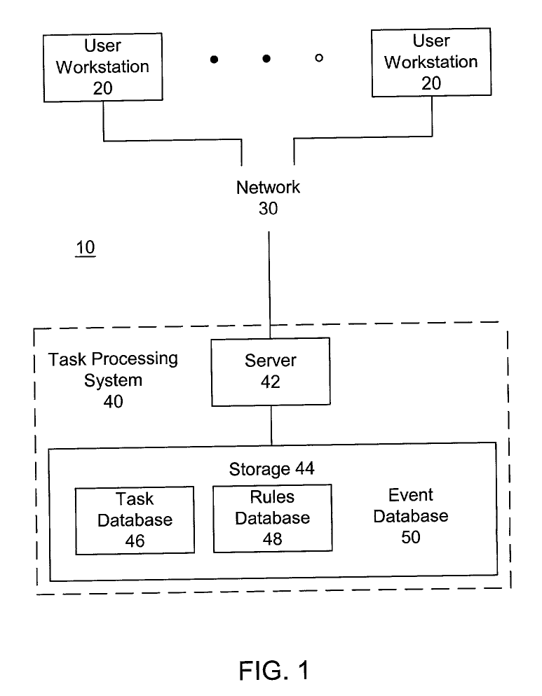

FIG. 1 is a block diagram of an automated task completion system 10 consistent with the present invention. As shown in FIG. 1, a system 10 includes one or more user workstations 20, a network 30, and a task processing system 40. Each of the user workstations 20 is connected to the network 30, which is also connected to the task processing system 40.

The user workstation 20 may include a CPU, a main memory, a ROM, a storage device and a communication interface all coupled together via a bus. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

A communication interface provides a two-way data communication coupling via a network link to the network 30. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information, to and from the network 30. The network 30 may be implemented, for example, as a LAN or as a public network, such as the Internet.

The user workstation 20 can send messages and receive data, including program code, through the network 30. If the network 30 is implemented as the Internet, the task processing system 40 can transmit a requested code for an application program through the Internet, an ISP, the local network and the communication interface. The received code can be executed by the CPU in the user workstation 20 as it is received, stored in the storage device, or stored in some other non-volatile storage for later execution. In this manner, the user workstation 20 may obtain application code in the form of a carrier wave.

The task processing system 40 includes a server 42 and a storage 44. The server 42 may have the same elements as the workstation 20, including a CPU, a main memory, a ROM, and a communication interface all coupled together via a bus. The storage 44 may be implemented as a non-volatile storage that may be incorporated into the server 42 or may be outside of the server 42. The storage 44 may be implemented as a single storage device or may be a plurality of storage devices located in a single location or distributed across multiple locations.

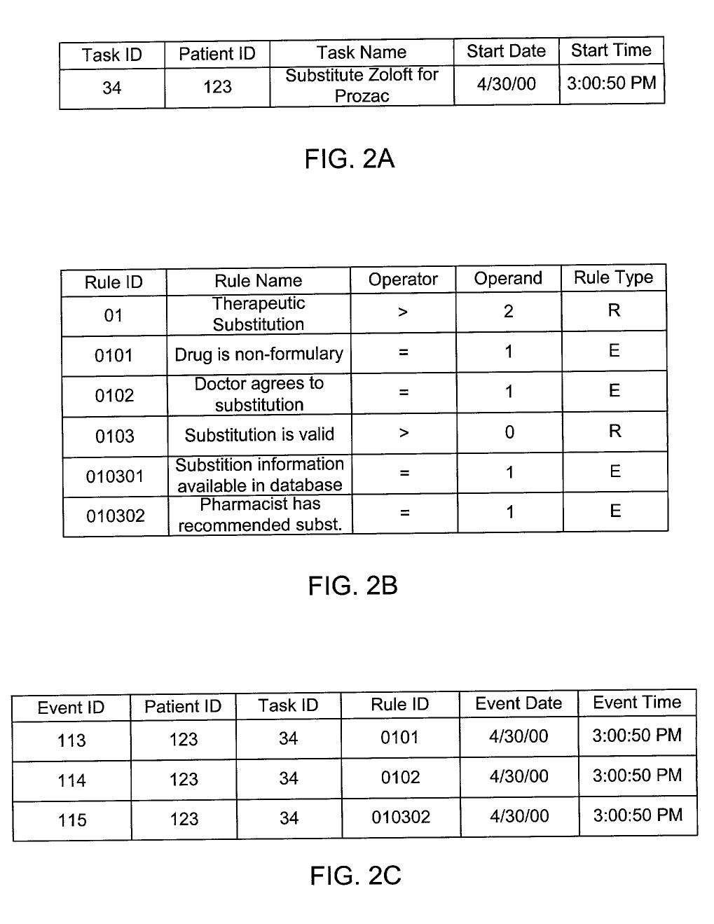

The storage 44 includes a task database 46, a rules database 48 and an event database. The task database 46 stores information regarding the different tasks that are submitted by a user from the workstation 20. Each task stored in the task database 46 preferably includes information about who submitted the task, the type of task, what is being requested in the task, when to complete the task, and any other information that may be necessary for completing the task. FIG. 2A shows an example of an entry in the task database 46. As shown in FIG. 2A, the task database 46 includes a task ID, a patient ID, a task name, a start date and a start time. FIG. 2A also shows exemplary values for each of the categories of the task database 46.

The rules database 48 stores information regarding the different rules applicable to the tasks stored in the task database 46. Each rule stored in the rules database 48 preferably includes a name, identification and type of rule, dependency information and rule type. FIG. 2B shows an example of multiple entries in the rules database 48. As shown in FIG. 2B, the rules database 48 includes a rule ID, a rule name, an operator, an operand and a rule type. FIG. 2B also shows exemplary values for each of the categories of the rules database 48.

The event database 50 stores information regarding the different events that are applicable to a particular patient. Each event stored in the event database 50 preferably includes information about what the event is, to which patient, task and rule the event is applicable, and the timing of the event. FIG. 2B shows an example of multiple entries in the event database 50. As shown in FIG. 2C, the event database 50 includes an event ID, a patient ID, a task ID, a rule ID, an event date and an event time. FIG. 2B also shows exemplary values for each of the categories of the event database.

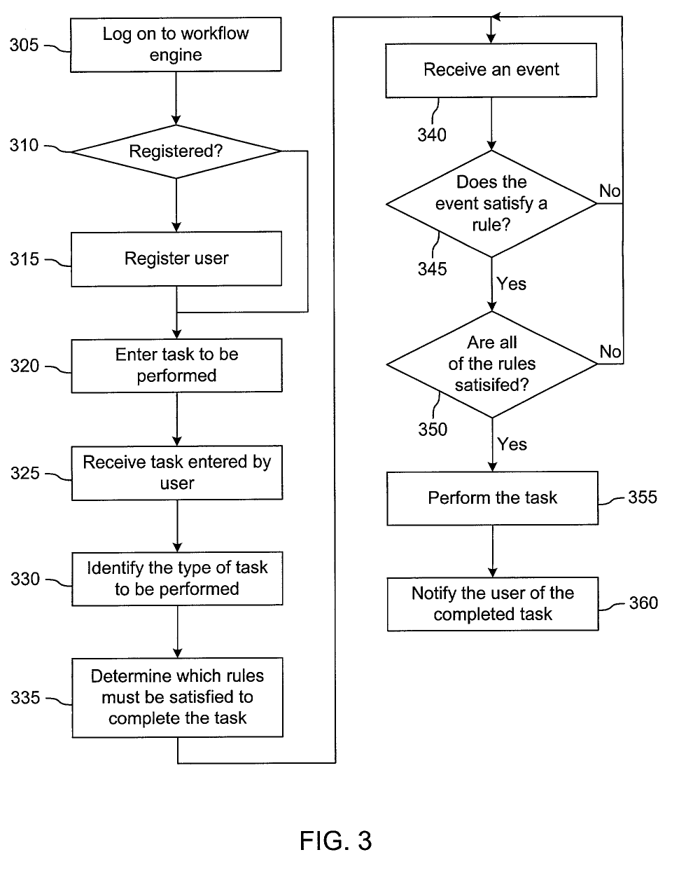

FIG. 3 is a representative example of a flow diagram of an automates task completion process consistent with the present invention. As shown in FIG. 2, a user, such as a patient or doctor, logs on to the task processing system 40 through the user workstation 20 (step 305). If the network 30 is implemented as the Internet, then the user may access the task processing system 40 by accessing the Internet, such as through an Internet Service Provider (ISP), locate the web site at which the task processing system 40 is located, and connect to that web site. To then log on to the task processing system 40, the user may be required to enter a username and password before being given access to the content of the task processing system 40. If the network 30 is implemented as a LAN, then all users of the workstations 20 in the LAN may have access to the task processing system 40.

After logging on to the task processing system 40, it is determined whether the user is registered (step 310). This determination may be made automatically when the user logs on to the task processing system 40. For example, if the task processing system 40 is accessed through a web site over the Internet, a cookie may be left in the user workstation 20 when the user is originally registered, and the cookie is read automatically by the task processing system 40 when the user logs on to determine whether the user is registered.

If the user is not registered, then the user may be required to register with the task processing system 40 (step 315). Registration with the task processing system 40 may require the user to enter identification information and other relevant information, as well as to create a username and password. For example, when the automated task completion system 10 is implemented for a healthcare organization, the other relevant information may include information about the user's insurance, the user's doctor, and other medically-related information. Depending on the task processing system 40, the user may need to pay a fee to register, or may need permission to register from a person running the task processing system 40. Although registration is not required, it allows the user to enter identification and other relevant information that may be needed to work with the task processing system 40 the first time the user accesses the task processing system 40 and have that information available for future accesses without re-entry.

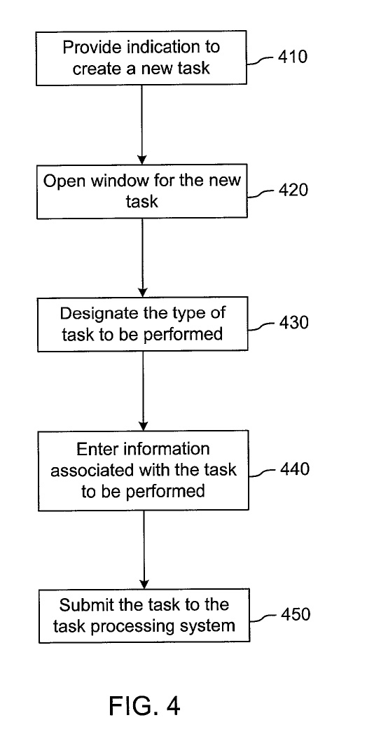

Having logged on and registered with the task processing system 40, the user can then enter a task to be performed (step 320). FIG. 4 is a flow diagram of an example of a process for entering a task in the task processing system 40 consistent with the present invention. As shown in FIG. 4, the user indicates to the task processing system 40 to create a new task (step 410). The user may make this indication by pulling down a menu in a graphical user interface (GUI) provided by the server 42. The menu may include various functions that may be performed by the user, including the creation of a new task. Alternatively, the GUI may have an icon that is clicked on by the user with a pointing device, such as a mouse, to create the new task.

In response to the indication, a window opened for entering information relating to the task (step 420). The window may have a plurality of fields to fill in information relating to the task. Each field may specify the type of information to include. In one of the fields in the window, the user designates the type of task or task name to be performed (step 430). The type of task depends upon the environment for which the task processing system 40 is being used. For example, when the automated task completion system 10 is implemented for a healthcare organization, the tasks may include making an appointment, filling a prescription, a therapeutic substitution or obtaining a physician referral. The type of task may be selected from a menu of available tasks.

In addition to the type of task, the user fills in any other information needed to complete the task (step 440). This other information may include a patient identification, a start date and a start time. For example, if the task is to make a therapeutic substitution, the other information to fill in may include the drug being used, the drug to substitute for the drug being used and the identification of the patient for whom the substitution is being made. The fields to fill in information may change depending upon the type of task designated by the user. By designating the task type to be a therapeutic substitution, the fields may include ones for the task identification, the patient identification, the task name, the start date and the start time.

After filling in all of the task information, the task is submitted to the task processing system 40 (step 450). The user may submit the task by clicking an icon in the window in which the task information is entered. The task is submitted to the task processing system 40 from the user workstation 20 via the network 30.

Returning to FIG. 3, the submitted task is received by the server 42 of the task processing system 40 (step 325). The task received by the server 42 may be processed and stored in the task database 46 of the storage 44. The task stored in the task database 46 preferably includes an identification of the user or patient submitting the task that enables registration information associated with the user/patient to be accessed when the task is being processed. In addition to storing the task in the task database 46, the server 42 identifies the type of task to be performed (step 330). As discussed above, the user includes a designation of the type of task in the task that is submitted to the task processing system 40. This designation is identified by the server 42 to determine the type of task.

Based on the determined task type, the rules which much be satisfied to complete the identified task are determined (step 335). For each type of task stored in the task database 46, there are a set of rules that must be satisfied to complete the task. The set of rules are determined by referencing the rules database 48. For example, the task shown in FIG. 2A is a therapeutic substitution for substituting Zoloft for Prozac. The set of rules associated with the task of a therapeutic substitution are shown in FIG. 2B.

As shown in FIG. 2B, the set of rules associated with the task of a therapeutic substitution include several rules, as well as a hierarchy of rules. The name of the first rule is the therapeutic substitution having an ID of 01. According to this rule, more than two other rules, referred to as sub-rules, must be satisfied to satisfy the therapeutic substitution. These sub-rules are identified with IDs 0101, 0102, and 0103. Specifically, the sub-rules are that the drug is non-formulary, that the doctor agrees to the substitution, and that the substitution is valid. The last of the sub-rules, that the substitution is valid, is satisfied if more than zero sub-rules, i.e. at least one sub-rule, are satisfied. The sub-rules corresponding to the substitution being valid are that the substitution information is available in the database and that the pharmacist has recommended the substitution, with the IDs for these sub-rules being 010301 and 010302, respectively.

After determining which rules must be satisfied, an event is received (step 340). Each event received by the task processing system 40 is stored in the event database 50. As described above, each event includes an ID, the ID of the patient, the task and the associated rule, and the event data and time. The events may be entered into the task processing system 40 by the typical source of the event information. For example, for the rule that the doctor agrees to the substitution, the doctor associated with the patient would typically be the user entering the event into the task processing system 40. Other events may be entered into the task processing system automatically by reference to a database of relevant information. For example, for the rules that the drug is non-formulary and that the substitution information is available in the database, the database of relevant information may be referenced to determine whether the drug being substituted for the existing drug is non-formulary and to determine whether information regarding such a substitution is in the database.

When an event is received, it is determined whether the received event satisfies a rule associated with the task (step 345). To determine whether the event satisfies the rule, the information associated with the received event is checked against the rules associated with the task. For example, if the received event indicates that the drug is non-formulary, then 0101 for the therapeutic substitution is satisfied. If the received event does not satisfy a rule, then the task processing system 40 waits to receive another event.

If the received event does satisfy a rule, then the task processing system 40 determines whether all of the rules associated with the task are satisfied (step 350). For example, to satisfy all of the rules of the therapeutic substitution shown in FIG. 2B, the received events must include that the drug is non-formulary, the doctor agrees to the substitution and either the substitution information is available in the database or a pharmacist has recommended the substitution. If all of the rules have not yet been satisfied, then the task processing system 40 waits to receive another event.

Once all of the rules associated with the task have been satisfied, the task is performed (step 355). For example, if all of the rules associated with the therapeutic substitution are satisfied, then the therapeutic substitution can be executed. For the example shown in FIG. 2B, the substitution of Zoloft for Prozac would be done.

When the task has been performed, a notification is sent to the user (step 360). The notification may be, for example, by e-mail, although other forms of notification may also be used including by telephone or beeper. In addition to indicating that the task has been completed, the notification preferably includes information about the result of the completion of the task. This information generally depends upon the task type. For example, if the task is to make an appointment, then the notification would include the time and date of the appointment and any additional information if the time of the appointment was different from the requested time. For the therapeutic substitution, the notification may include the cost of the filling the prescription for the substitution, where the substituted prescription is being delivered, and the expected date of delivery.

Although the automated task completion system 10 is preferably implemented for a healthcare organization for processing healthcare related tasks, the automated task completion system 10 may be implemented in other environments. For example, the automated task completion system 10 may be implemented in a retail environment, where the tasks, rules and event are established to process the different types of tasks, such as purchasing an item, requesting a catalog, seeking a return or refund, or a customer service related task, such as undelivered or broken merchandise. The automated task completion system 10 may be useful for any organization in which the system is implemented that processes tasks where the rules and events associated with the tasks may be identified, received and processed.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method performed in a computer system for the automatic completion of a healthcare related task, comprising:
receiving a request at the computer system via a network from a user to complete a healthcare related task;
identifying a plurality of rules that must be satisfied to complete the task from a database stored in the computer system;
recognizing the occurrence of an event associated with the task;
determining whether the event satisfies all of the plurality of rules that must be satisfied to complete the task; and
repeating the recognizing and determining if any of the plurality of rules have not been satisfied.

2. A method according to claim 1, wherein the request includes information identifying the type of task to be performed.

3. A method according to claim 2, wherein the request further includes information identifying the user making the request, a start time, and an end time.

4. A method according to claim 1, further comprising identifying the type of task to be performed from the request, wherein the plurality of rules are identified in accordance with the identified type of task.

5. A method according to claim 1, further comprising:
determining if a first one of the plurality of rules may be satisfied by the occurrence of any of two or more events;
recognizing that the first one of the plurality of rules has been satisfied after receiving one of the any of two or more events.

6. A method according to claim 1, further comprising:
performing the task if all of the plurality of rules have been satisfied; and
transmitting a notification to the user who submitted the request when the performance of the task has been completed.

7. A method according to claim 6, wherein the notification includes information related to the type of task included in the request.

8. A method according to claim 1, wherein each event includes information identifying the applicable task and the applicable rule.

9. A computer system for the automatic completion of a healthcare related task, comprising:
a processor;
a memory, coupled to the processor, comprising a plurality of instructions executed by the process, the plurality of instructions configured to:
receive a request at the computer system via a network from a user to complete a healthcare related task;
identify a plurality of rules that must be satisfied to complete the task from a database stored in the computer system;
recognize the occurrence of an event associated with the task;
determine whether the event satisfies all of the plurality of rules that must be satisfied to complete the task; and
repeat the recognize and determine instructions if any of the plurality of rules have not been satisfied.

10. A computer system according to claim 9, wherein the request includes information identifying the type of task to be performed.

11. A computer system according to claim 10, wherein the request further includes information identifying the user making the request, a start time, and an end time.

12. A computer system according to claim 9, the memory further comprising an instruction configured to identify the type of task to be performed from the request, wherein the plurality of rules are identified in accordance with the identified type of task.

13. A computer system according to claim 9, the memory further comprising instructions configured to:
determine if a first one of the plurality of rules may be satisfied by the occurrence of any of two or more events;
recognize that the first one of the plurality of rules has been satisfied after receiving one of the any of two or more events.

14. A computer system according to claim 9, the memory further comprising instructions configured to:
perform the task if all of the plurality of rules have been satisfied; and
transmit a notification to the user who submitted the request when the performance of the task has been completed.

15. A computer system according to claim 14, wherein the notification includes information related to the type of task included in the request.

16. A computer system according to claim 9, wherein each event includes information identifying the applicable task and the applicable rule.

17. A computer readable medium operable on a computer system for the automatic completion of a healthcare related task, the computer readable medium configured to:
receive a request at the computer system via a network from a user to complete a healthcare related task;
identify a plurality of rules that must be satisfied to complete the task from a database stored in the computer system;
recognize the occurrence of an event associated with the task;
determine whether the event satisfies all of the plurality of rules that must be satisfied to complete the task; and
repeat the recognize and determine instructions if any of the plurality of rules have not been satisfied.

18. A computer readable medium according to claim 17, wherein the request includes information identifying the type of task to be performed.

19. A computer readable medium according to claim 18, wherein the request further includes information identifying the user making the request, a start time, and an end time.

20. A computer readable medium according to claim 17, further configured to identify the type of task to be performed from the request, wherein the plurality of rules are identified in accordance with the identified type of task.

21. A computer readable medium according to claim 17, further configured to:
determine if a first one of the plurality of rules may be satisfied by the occurrence of any of two or more events;
recognize that the first one of the plurality of rules has been satisfied after receiving one of the any of two or more events.

22. A computer readable medium according to claim 17, further configured to:
perform the task if all of the plurality of rules have been satisfied; and
transmit a notification to the user who submitted the request when the performance of the task has been completed.

23. A computer readable medium according to claim 22, wherein the notification includes information related to the type of task included in the request.

24. A computer readable medium according to claim 17, wherein each event includes information identifying the applicable task and the applicable rule.
